(19) United States
(12) Patent Application Publication
(10) Pub. No.: US 2017/0120995 A1
(43) Pub. Date: May 4, 2017

(54) ORAL INFLATION TUBE WITH RELIEF FUNCTION

(71) Applicant: WILLIAM LEE, TAIPEI (TW)

(72) Inventor: WILLIAM LEE, TAIPEI (TW)

(21) Appl. No.: 14/931,194

(22) Filed: Nov. 3, 2015

(51) Int. Cl. B60C 29/00; F16K 15/20

(52) U.S. Cl. CPC B63C 9/24; F16K 15/20

(57) ABSTRACT

An oral inflation tube with a pressure relief function is revealed. The oral inflation tube includes an elongated tube with a first opening end at one end and a second opening end at the other end. The first opening end is mounted with an out-to-in one-way valve to form an inflation port. The second opening end is connected to a 90-degree turn and used for connection to an inflatable article. The oral inflation tube features on an opening integrally formed on a tube wall of the elongated tube. The opening includes an inner tube wall extended a certain length inward so that a pressure relief valve is sealingly mounted in the opening and communicated with an inner channel of the elongated tube.

### BACKGROUND OF THE INVENTION

The present invention relates to an oral inflation tube used for inflating an inflatable article connected thereto, especially to an oral inflation tube that provides a pressure relief function without affecting the original appearance thereof.

While doing sports or leisure activities on the sea, various inflatable articles including personal flotation devices, life rafts, buoys, emergency signaling equipment, etc are required. These inflatable articles are used together with an inflator, as those revealed in U.S. Pat. No. 3,809,288, U.S. Pat. No. 3,997,079, U.S. Pat. No. 4,223,805, U.S. Pat. No. 4,267,944, U.S. Pat. No. 4,260,075, U.S. Pat. No. 4,627,823, U.S. Pat. No. 2,264,321, U.S. Pat. No. 3,754,291, U.S. Pat. No. 4,498,879, U.S. Pat. No. 4,560,356, U.S. Pat. No. 4,627,823, U.S. Pat. No. 5,297,576, etc.

Moreover, according to regulations of European Union and USA Coast Guard, a conventional inflatable life jacket should be equipped with an oral inflator (or oral inflation tube). In the field, the appearance of the conventional oral inflator is similar to that of the embodiments in FIG. 1, FIG. 4 and FIG. 7. The oral inflator includes an elongated tube integrally formed by injection molding and made from plastic or the like materials. One end of the elongated tube is an opening end for mounting a one-way intake valve. While in use, the opening end is covered with a dust cap used for dust-proof and manual deflation. The other end of the elongated tube is a turned portion connected an opening end with a mounting flange. The turned portion is 90 degrees and the opening end is connected to inflatable articles. Although a relief valve is optional, it has been broadly used in SOLAS (Safety Of Life At Sea) life jackets. The SOLAS life jacket should include two bladders and two CO₂ cylinders. Thus the bladder is easy to be overpressure. Thus the relief valve is required for protection of the bladder.

Refer to U.S. Pat. No. 5,297,576, it provides a solution to the use of the oral inflator and the relief valve. An oral inflation and relief tube for connection to an inflatable article is revealed. The oral inflation and relief tube includes an elongated tube having an oppositely positioned first opened end and second end, with a flanged opening positioned therebetween at ninety degrees connection to the inflatable articles; an inflation valve sealingly positioned within said first opened end; a relief valve sealingly positioned within said second opened end. In brief, an elongated tube is in an in-line configuration. The inflation valve and the relief valve are respectively disposed on tow ends of the elongated tube respectively, as shown in FIG. 1. However, the above design still has the shortcomings. Besides two opening ends projecting outwards, the elongated tube includes one more projecting opening end for mounting the relief valve. Thus there are three projecting opening ends on the relief valve. After long term use, the life jackets are easy to have abrasion and scratching due to projecting opening ends. Moreover, refer to U.S. Pat. No. 7,021,326, a combination inflation and relief valve is revealed. There is no more projecting for mounting the relief valve on the appearance of the elongated tube. However, the design is unable to be used on life jackets. This is due to a dust cap for dust-proof or manual deflation of the life jacket covered on the opening end of the oral inflator of the life jacket. This affects the function of the relief valve.

### SUMMARY OF THE INVENTION

Therefore it is a primary object of the present invention to provide an oral inflation tube with a relief function for overpressure protection. The oral inflation tube includes an elongated tube. One end of the elongated tube is a first opening end used tightly mounted with an out-to-in one-way valve so as to form an inflation port. The other end of the elongated tube is a second opening end having a mounting flange and connected to a turn which is 90 degrees. The second opening end is used for connection to an inflatable article. An inner channel is formed and communicated between the first opening end and the second opening end of the elongated tube. The oral inflation tube features on that an opening is integrally formed on a tube wall of the elongated tube, without affecting the shape and appearance of the elongated tube. The opening includes an inner tube wall extended inward a certain length. Thus a pressure relief valve is sealingly mounted in the opening and communicated with the inner channel of the elongated tube. The oral inflation tube with the relief function provides overpressure protection, without projecting from the appearance of the elongated tube.

The opening can be located at the 90-degree turn, perpendicular or parallel to the opening end with the mounting flange. The opening can also be arranged at the elongated tube and located between the first opening end and the second opening end.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is a top view of the embodiment in FIG. 1;

FIG. 3 is a cross sectional view along a line 3-3 in FIG. 2;

FIG. 4 is a perspective view of another embodiment according to the present invention;

FIG. 5 is a top view of the embodiment in FIG. 4;

FIG. 6 is a cross sectional view along a line 6-6 in FIG. 5;

FIG. 7 is a perspective view of a further embodiment according to the present invention;

FIG. 8 is a top view of the embodiment in FIG. 7;

FIG. 9 is a cross sectional view along a line 9-9 in FIG. 8;

FIG. 10 is a longitudinal sectional view of an embodiment with a pressure relief valve according to the present invention;

FIG. 11 is a schematic drawing showing the embodiment in FIG. 10 in a pressure relieved state according to the present invention;

FIG. 12 is a longitudinal sectional view of an embodiment with another pressure relief valve according to the present invention;

FIG. 13 is a schematic drawing showing the embodiment in FIG. 12 in a pressure relieved state according to the present invention;

FIG. 14 is a longitudinal sectional view of an embodiment with a further pressure relief valve according to the present invention;

FIG. 15 is a schematic drawing showing the embodiment in FIG. 14 in a pressure relieved state according to the present invention.

### DETAILED DESCRIPTION OF THE PREFFERED EMBODIMENT

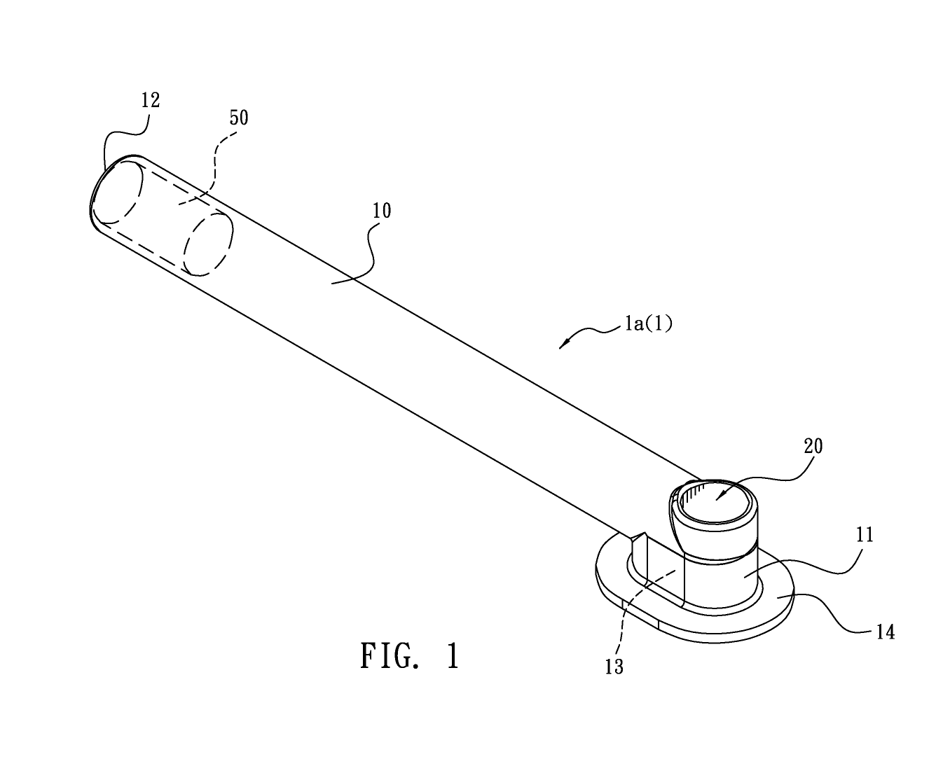

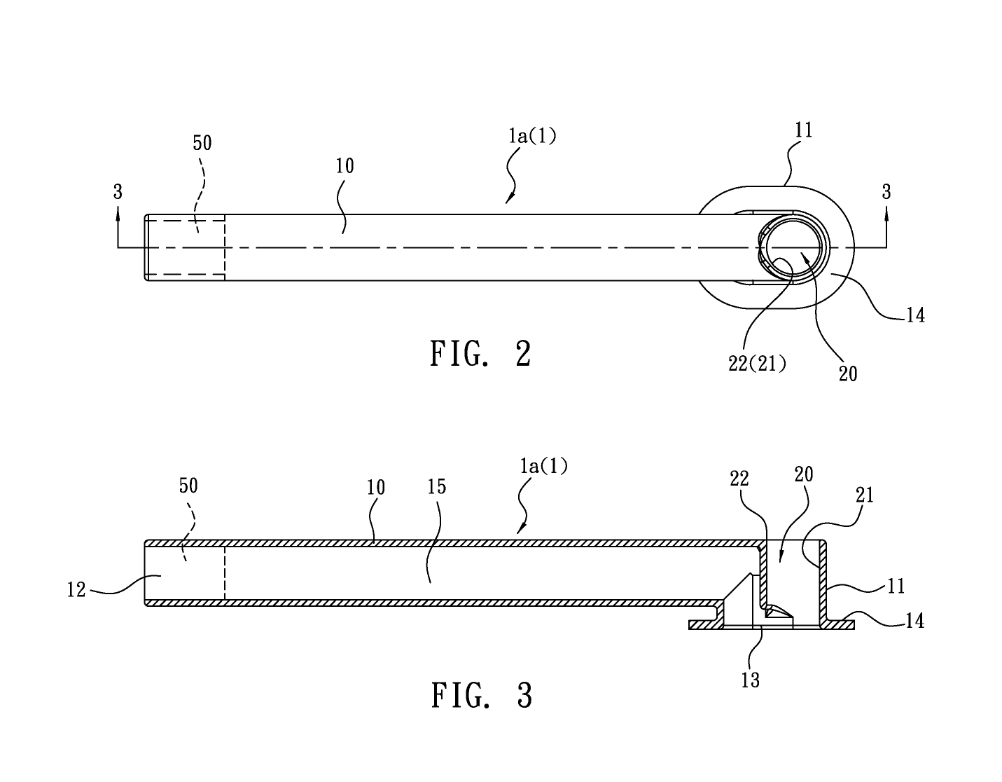

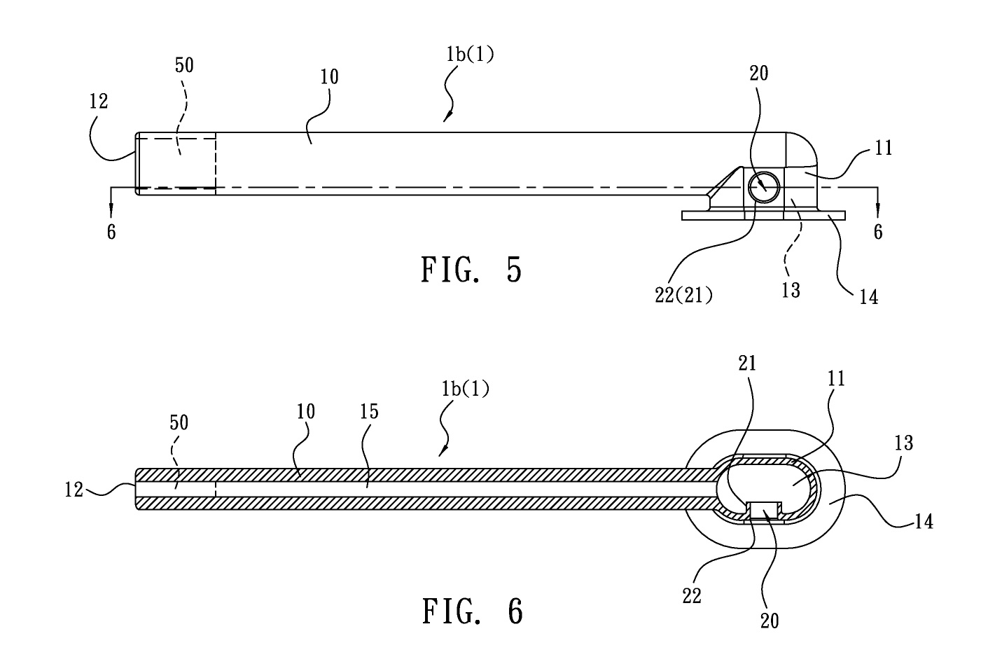

Refer from FIG. 1 to FIG. 9, an oral inflation tube 1 (1a, 1b, 1c) with a relief function includes an elongated tube 10, a turn 11, a first opening end 12, a second opening end 13, a mounting flange 14 and an inner channel 15. The first opening end 12 is formed on one end of the elongated tube 10 and is used for tightly mounted with an out-to-in one-way valve 50. The first opening end 12 together with the one-way valve 50 is used as an inflation port. The other end of the elongated tube 10 is the second opening end 13 having a mounting flange 14 and connected to the turn 11 that is 90 degrees. The second opening end 13 is used for connection to an inflatable article (not shown in figure). The inner channel 15 is formed and communicated between the first opening end 12 and the second opening end 13 of the elongated tube 10.

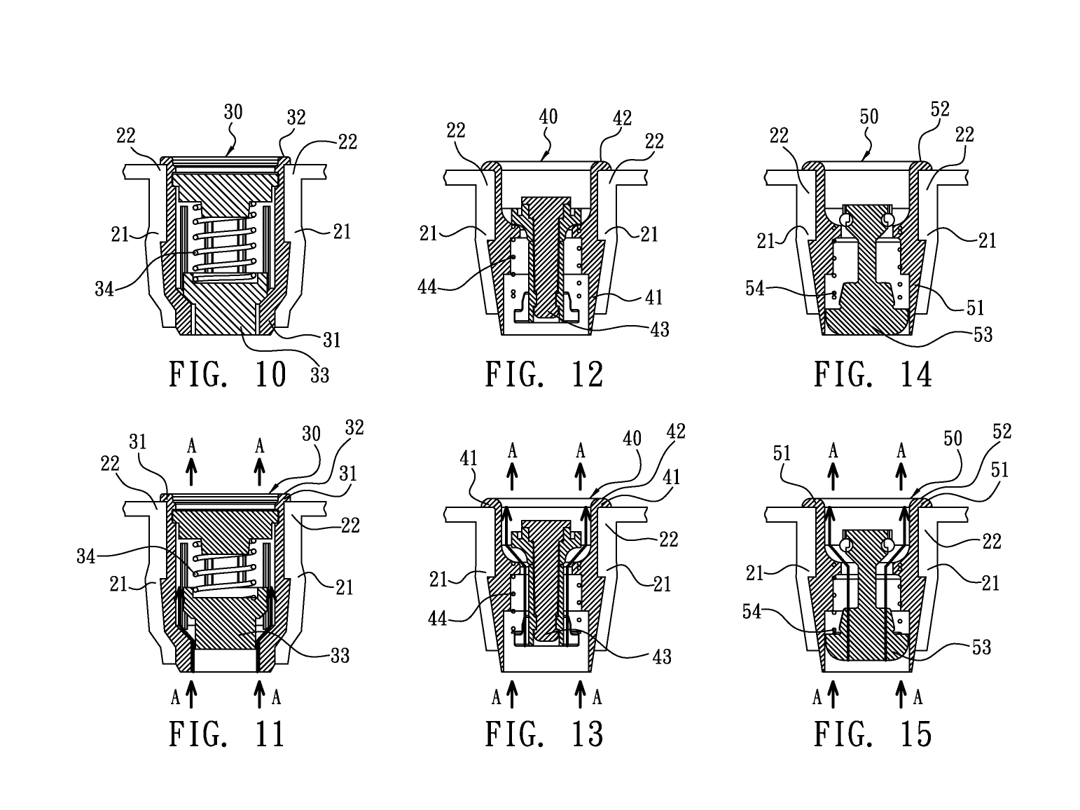

The present invention features on that an opening 20 is integrally formed on a tube wall of the elongated tube 10 without changing the shape and appearance of the elongated tube 10. The opening 20 is formed by an opening edge 22 and an inner tube wall 21 extended inward a certain length. A pressure relief valve (30, 40, 50) (as shown in FIG. 10 to FIG. 15) is sealingly mounted in the opening 20 and communicated with the inner channel 15 of the elongated tube 10. Thus the oral inflation tube 1 (1a, 1b, 1c) provides the relief function. Moreover, there is no protrusion on the appearance of the elongated tube 10. Thus the shortcoming of the conventional oral inflation tube (such as the one revealed in U.S. Pat. No. 5,297,576) that is easy to cause abrasion ad scratching of the life jacket/cover due to three opening ends projecting outward thereof can be avoided.

The elongated tube 10 is integrally formed by injection molding and made from plastic or the like materials. Thus the tube wall of the elongated tube 10 and the inner tube wall 21 of the opening 20 both have proper toughness (or flexibility). Thus when a pressure relief valve (30, 40, 50) (as shown in FIG. 10 to FIG. 15) is mounted into and fixed in the opening 20, the pressure relief valve and the inner tube wall 21 of the opening 20 press each other relatively to have a good seal.

Moreover, the pressure relief valve has various forms, refer to the pressure relief valve 30 shown in FIG. 10 and FIG. 11, the pressure relief valve 40 shown in FIG. 12 and FIG. 13, and the pressure relief valve 50 shown in FIG. 14 and FIG. 15. Generally, the pressure relief valve 30, 40, 50 includes a cylindrical housing 31, 41, 51, an opening flange 32, 42, 52, a moving cylinder 33, 43, 53 and a return spring 34, 44, 54. When the gas pressure in the inner channel 15 of the elongated tube 10 (the internal gas pressure of the article connected to the second opening end 13 and going to be inflated) has not reached a preset value, a spring force of the return spring 34, 44, 54 will force the pressure relief valve 30, 40, 50 to be gas tight. Thus the pressure relief valve 30, 40, 50 is in a pressure unrelieved state, as shown in FIG. 10, FIG. 12 and FIG. 14. Once the gas pressure in the inner channel 15 of the elongated tube 10 has reached or over the preset value (in an overpressure state), the spring force of the return spring 34, 44, 54 is insufficient to force the pressure relief valve 30, 40, 50 to be gas tight. Thus the moving cylinder 33, 43, 53 is moved in opposite direction to form a gas flow channel, as the arrow A in FIG. 11, FIG. 13 and FIG. 15 indicated. Therefore gas is flowing from inside to outside through the gas flow channel and the pressure relief valve 30, 40, 50 is in a pressure relieved state.

During manufacturing of the oral inflation tube, first select a pressure relief valve 30, 40, 50 and form an opening 20 that matches the size or the diameter of the cylindrical housing 31, 41, 51 of the pressure relief valve 30, 40, 50 on the tube wall of the elongated tube 10. For example, the diameter of the opening 20 is a bit smaller than the size/diameter of the cylindrical housing 31, 41, 51 of the pressure relief valve 30, 40, 50 so as to achieve a good seal. Then the pressure relief valve 30, 40, 50 is mounted into the opening 20 on the tube wall of the elongated tube 10. The opening 20 includes an opening edge 22 with a certain thickness and the opening edge 22 of the inner tube wall 21 is extended inwards (toward the inner channel 15 of the elongated tube 10). Thus the cylindrical housing 31, 41, 51 of the pressure relief valve 30, 40, 50 and the inner tube wall 21 of the opening 20 can press each other tightly by the toughness (or flexibility) of the inner tube wall 21 so as to achieve a good sealing and positioning effect, as shown from FIG. 10 to FIG. 15.

Furthermore, the pressure relief valve 30, 40, 50 includes the opening flange 32, 42, 52. While assembling the pressure relief valve 30, 40, 50, the opening flange 32, 42, 52 is pressed against the opening edge 22 of the opening 20 for a better sealing and positioning effect, as shown FIG. 10 to FIG. 15.

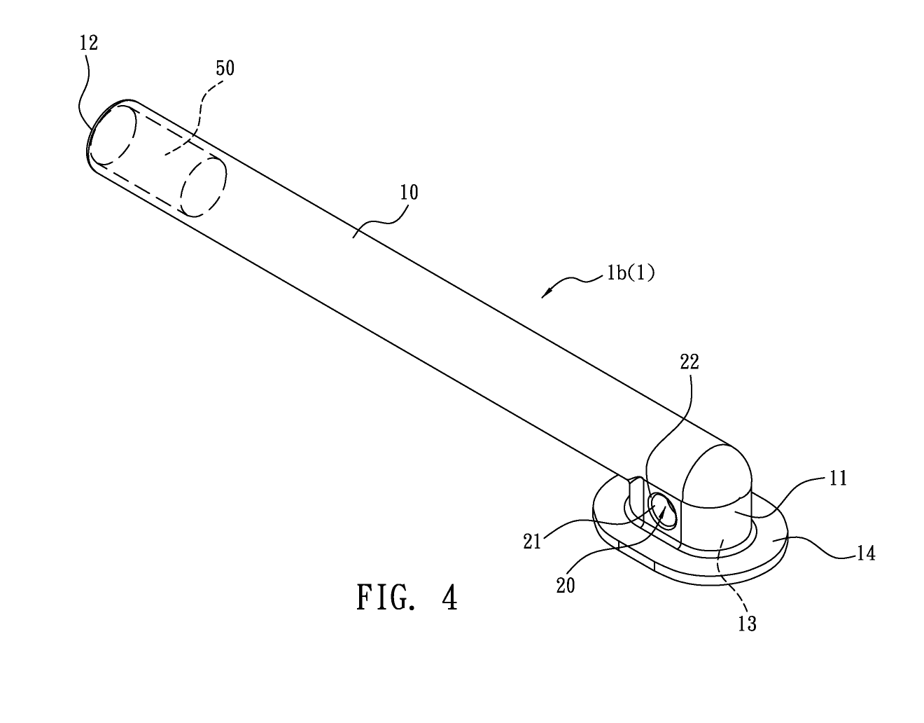

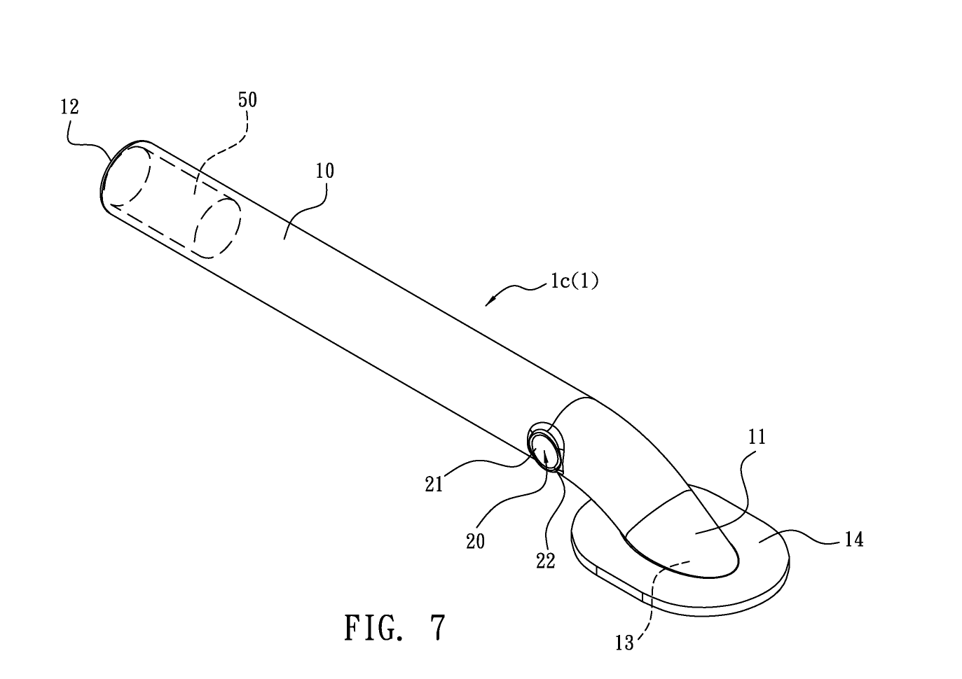

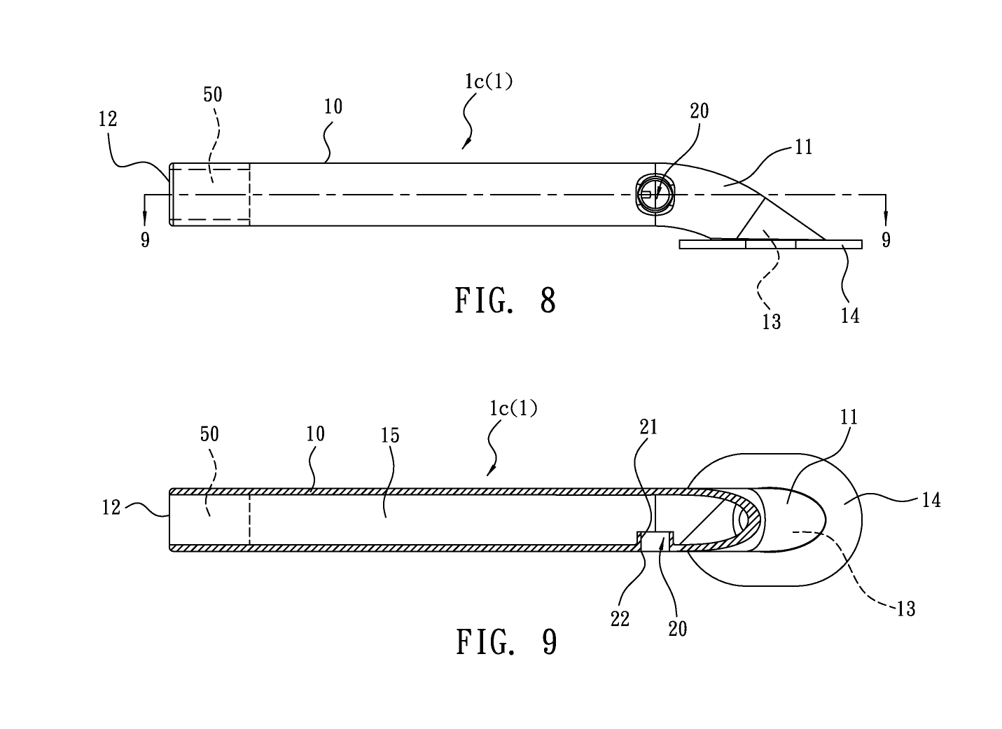

In addition, the position of the opening 20 integrally formed on the tube wall of the elongated tube 10 is not limited in the present invention. In the embodiment shown in FIG. 1 to FIG. 3, the opening 20 is arranged at the 90-degree turn 11 while the inner tube wall 21 of the opening 20 is perpendicular to the opening end 13 with the mounting flange 14. The inner tube wall 21 of the opening 20 includes a part of the tube wall of the turn 11. This is beneficial to manufacturing of the elongated tube 10 by injection molding. Refer to the embodiment shown in FIG. 4 to FIG. 6, the opening 20 is mounted on the 90-degree turn 11 while the inner tube wall 21 of the opening 20 is parallel to the opening end 13 with the mounting flange 14. Refer to FIG. 7, FIG. 8 and FIG. 9, the opening 20 of this embodiment is set on the tube wall of the elongated tube 10 between the first opening end 12 and the second opening end 13 while the inner tube wall 21 of the opening 20 is parallel to the opening end 13 with the mounting flange 14.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An oral inflation tube comprising:
an elongated tube,
a first opening end formed on one end of the elongated tube and used for tightly mounted with an out-to-in one-way valve so as to form an inflation port;
a second opening end with a mounting flange, formed on the other end of the elongated tube and connected to a 90-degree turn; the second opening end used for connection to an inflatable article; and
an inner channel formed and communicated between the first opening end and the second opening end of the elongated tube;
wherein an opening is integrally formed on a tube wall of the elongated tube; the opening includes an opening edge and an inner tube wall extended inward a certain length so that a pressure relief valve is tightly mounted in the opening and communicated with the inner channel of the elongated tube.

2. The device as claimed in claim 1, wherein the opening is arranged at the 90-degree turn, and the inner tube wall of the opening is perpendicular to the second opening end with the mounting flange.

3. The device as claimed in claim 2, wherein the inner tube wall of the opening includes a part of a tube wall of the turn.

4. The device as claimed in claim 1, wherein the opening is set on the 90-degree turn, and the inner tube wall of the opening is parallel to the second opening end with the mounting flange.

5. The device as claimed in claim 1, wherein the opening is disposed on the tube wall of the elongated tube and located between the first opening end and the second opening end.

6. The device as claimed in claim 5, wherein the inner tube wall of the opening is parallel to the second opening end with the mounting flange.

7. The device as claimed in claim 1, wherein the elongated tube is integrally formed by injection molding and made from plastic or the like materials so that both the tube wall of the elongated tube and the inner tube wall of the opening have toughness.

8. The device as claimed in claim 1, wherein a diameter of the opening edge of the opening and a diameter of the inner tube wall of the opening are a bit smaller than a diameter of the pressure relief valve;
thus when the pressure relief valve is mounted into the opening on the tube wall of the elongated tube, the pressure relief valve and the opening press each other tightly to provide a good sealing and positioning effect.

9. The device as claimed in claim 1, wherein the pressure relief valve includes a cylindrical housing, an opening flange, a moving cylinder and a return spring; when gas pressure in the inner channel of the elongated tube has not reached a preset value, a spring force of the return spring forces the pressure relief valve to be gas tight; once the gas pressure in the inner channel of the elongated tube has achieved or over the preset value, the spring force of the return spring is insufficient to force the pressure relief valve to be gas tight; thus the moving cylinder is moved in opposite direction to form a gas flow channel, allowing the pressure relief valve to be a pressure relieved state.

10. The device as claimed in claim 9, wherein the pressure relief valve further includes an opening flange; while the pressure relief valve being mounted in the opening, the opening flange of the pressure relief valve is pressed against the opening edge of the opening tightly.
